(19) United States
(12) Patent Application Publication
(10) Pub. No.: US 2011/0307808 A1
(43) Pub. Date: Dec. 15, 2011

(54) RENDERING INCOMPATIBLE CONTENT WITHIN A USER INTERFACE

(75) Inventors: Daniel J. Giambalvo, Seattle, WA (US); Andrew D. Cox, Redmond, WA (US); Radu C. Margarint, Kenmore, WA (US)

(73) Assignee: Microsoft Corporation, Redmond, WA (US)

(21) Appl. No.: 12/797,869

(22) Filed: Jun. 10, 2010

(51) Int. Cl. G06F 3/01

(52) U.S. Cl. 715/760

(57) ABSTRACT

An increasing amount of the world's content resides on the web in a form targeted to web browser rendering. It may be advantageous to utilize this web content within non-web-based rich client applications because such rich client applications may provide robust features and/or interactions that web-based platforms lack. Unfortunately, integrating web content into non-web user interfaces may be a difficult task. Accordingly, one or more systems and/or techniques for rendering web content within a user interface are disclosed herein. In particular, a composition component may be configured to invoke one or more rendering components to generate rendered web content in a common format within a surface. The rendered web content may be provided to a user interface for display. An input component may be configured to invoke a rendering component to update rendered web content based upon interaction with rendered web content within the user interface.

### BACKGROUND

An increasing amount of content resides on the web in a form targeted to web browser rendering. For example, hyperlinks, 3D interactive objects, advertisements, web applications, and/or a variety of other content are provided to users in a web-based format, such as HTML. Authors of web-based content commonly develop such content within a web platform. Unfortunately, web design has various limitations, such as the robustness of application features, difficulty in designing advanced content, bandwidth considerations, the level of interactivity of the content, etc. However, non-web-based user interfaces, such as desktop applications, provide an enhanced experience to users. For example, a standalone client video game may offer advanced graphics, input, and/or programmable features. In contrast, a web-based video game may be restricted by limited graphics capabilities and/or other programming design limitations. Thus, there are limitations with providing web content within a non-web-based user interface.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for rendering web content within a user interface are disclosed herein. It may be appreciated that the user interface may comprise a non-web-based application, such as a rich client application configured to run on a general purpose operating system. It may also be appreciated that, as used herein, web content, while using the word “web”, is not limited to web-based content, but is to be interpreted as content that is incompatible with a user interface. For example, web-based HTML elements, non-web-based programming objects programmed in an incompatible programming language with respect to the user interface, a DirectX® object, etc. are merely some examples of what web content, as used herein, is intended to comprise. In some instances, web content may not be natively compatible with the user interface because the web content may have been authored within a different platform (e.g., a web platform, an API using a different programming language, etc.), whereas the user interface may have been authored within a different (e.g., desktop) platform using a different programming language and/or paradigm. That is, web content as used herein may be interchangeable with incompatible content, whether web-based or not. Additionally, rendered web content, while using the word “web”, is not limited to web-based content rendered by a web-based renderer, but is to be interpreted as content that is incompatible with a user interface. That is, rendered web content may be interchangeable with incompatible content, whether web-based or not.

Accordingly, a system comprising a composition component, an input component, and/or one or more rendering components are provided herein. The composition component may be configured to send a surface to one or more rendering components (e.g., a first rendering component). For example, the surface may be a container object (e.g., an image buffer) within which web content (incompatible content that is not limited to web-based content) may be rendered as imagery in a common format by rendering components. A first rendering component may receive the surface with instructions to render web content. The first rendering component may generate a first rendered web content within the surface. The first rendering component may send the surface comprising the first rendered web content back to the composition component. It may be appreciated that the composition component may send the surface with the first rendered web content and/or other rendered web content to other rendering components (e.g., a second rendering component) so that additional rendered web content (e.g., a second rendered web content) may be generated within the surface. In this way, the surface may comprise one or more rendered web content (e.g., a mixture of incompatible web-based content and incompatible non-web-based content; a mixture of incompatible non-web-based content and other incompatible non-web-based content using a different rendering technology; and/or a mixture of incompatible web-based content and other incompatible web-based content using a different rendering technology).

The composition component may be configured to provide the first rendered web content to the user interface. In one example, if the surface comprises a first and second rendered web content and the user interface requests both rendered web content, then the composition component may send both the first and second rendered web content as combined rendered web content to the user interface. In another example, if the surface comprises a first and second rendered web content and the user interface requests the first rendered web content, then the composition component may selectively send the first rendered web content and not the second rendered web content. In another example, if the user interface requests a portion of the first rendered web content, then the composition component may send the requested portion. In this way, the composition component may be configured to manage (e.g., break up or combine rendered web content within a surface) and/or provide web content requested by the user interface (e.g., provide a “brush” that may be painted within objects of the user interface, such as a cube). Thus, the user interface may consume and/or display the rendered web content within the user interface, regardless of the type of rendering component used. That is, the rendered web content may be in a common format regardless of whether an HTML, a DirectX®, or other renderer generated the rendered content, and thus may be compatible with the user interface. In one example, an HTML renderer may render a textbox as the first rendered web content at a location within a surface. The composition component may provide the first rendered web content to the user interface. The user interface may display the textbox.

It may be appreciated that the composition component may be configured to “break-up” rendered web content within a surface (e.g., imagery of a car and person) into portions (a car portion and a person portion). In this way, portions may be provided to a user interface, which may display the portions at the same or different locations, relative to their initial orientations relative to one another.

The input component may be configured to determine whether interaction occurred with the first rendered web content within the user interface (e.g., an event occurs, such as a mouseclick or timeout). For example, the input component may monitor the textbox within the user interface to determine whether a user clicked the textbox. It may be appreciated that a click property of the textbox may correspond to the textbox displaying a cursor within the text field, and thus the first rendered web content of the textbox may be updated (rerendered) to display the cursor within the text field. Upon detecting interaction, the input component may be configured to invoke the first rendering component to generate an updated version of the first rendered web content. For example, the input component may notify the first rendering component that the textbox was clicked. The notification may comprise the click event, a position of the mouse and/or a position of the textbox within the user interface. The first rendering component may generate the updated version of the first rendered web content (e.g., imagery of the textbox with a cursor within the text field), which may be sent to the composition component through a surface. In this way, the composition component may provide the user interface with the updated version, such that the user interface may display updated imagery of the textbox with the cursor within the text field. It may be appreciated that the first rendering component may “push” additional rendered web content without request (e.g., a video may require a sequence of rendered imagery that the first rendering component may sequentially render).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of rendering web content within a user interface.

FIG. 2 is a flow chart illustrating an exemplary method of rendering web content within a user interface.

FIG. 3 is a component block diagram illustrating an exemplary system for rendering web content within a user interface.

FIG. 4 is an illustration of an example of a composition component invoking multiple rendering components to generate rendered web content within a surface.

FIG. 5 is an illustration of an example of providing combined rendered web content to a user interface.

FIG. 6 is an illustration of an example of providing combined rendered web content to a user interface.

FIG. 7 is an illustration of an example of providing a first rendered web content to a user interface.

FIG. 8 is an illustration of an example of providing a first and second portion of a first rendered web content to a user interface.

FIG. 9 is an illustration of an example of an input component invoking a first rendering component to generate an updated version of a first rendered web content within a surface.

FIG. 10 is an illustration of an exemplary computer-readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Personal computers, PDAs, tablet PCs, smart phones, and a variety of other technology provide users with access to rich web content. For example, a user may play a video game through a social networking website using a tablet PC. In another example, a user may map driving directions on a smart phone. Due to the increasing popularity of the web as a means to search, explore, consume, and share content, developers often choose a web-based authoring platform for developing new content. For example, encyclopedia applications were commonly developed to execute through a rich client application (e.g., a window based application), which were distributed through software bundles comprising multiple CDs or DVDS (e.g., a 10 CD set). However, today encyclopedia content is commonly web-based content, such as interactive web pages and web applications, because a vast amount of users may easily find and consume the web content as opposed to purchasing a desktop application, installing the desktop application, and consuming the content within the desktop application.

It may be advantageous to provide web content within a user interface because a vast amount of new content is developed as web content, which may be provided within a user interface with the ability to provide a more robust and interactive experience than a web interface. It may be appreciated that a user interface may be interpreted as a non-web-based application, and may be referred to as a rich client application, a user interface, a non-web-based application, and/or a desktop application, which are different than a dedicated web interface. One current technique attempts to provide web content within a user interface by providing a user interface with a “brush” that allows the user interface to paint pieces of a web page on surfaces of the user interface. Unfortunately, the painted surfaces are not interactive (e.g., when a user selects a hyperlink, then there is no functionality to update the hyperlink with a new color to show the selection occurred). Another current technique provides limited interactive HTML-rendered surfaces. However, the rendered surfaces are constrained inside an HTML window.

Accordingly, one or more systems and/or techniques for rendering web content within a user interface are provided herein. In particular, one or more rendering components may be configured to render web content in a corresponding format. For example, a first rendering component may be configured to generate HTML web content, a second rendering component may be configured to generate DirectX® rendered content, etc. The rendering components may be configured to render web content in a common format within a surface. A composition component may pass the surface amongst rendering components to “collect” rendered web content within the surface. The composition component may be configured to provide rendered content within the surface to a user interface. In one example, a first rendered content or a portion thereof may be provided to the user interface. In another example, a combination of a first rendered web content rendered by a first rendering component and a second rendered web content rendered by a second rendering component may be provided to the user interface. An input component may be configured to invoke a rendering component to provide an updated version of rendered web content based upon user interaction with the rendered web content within the user interface.

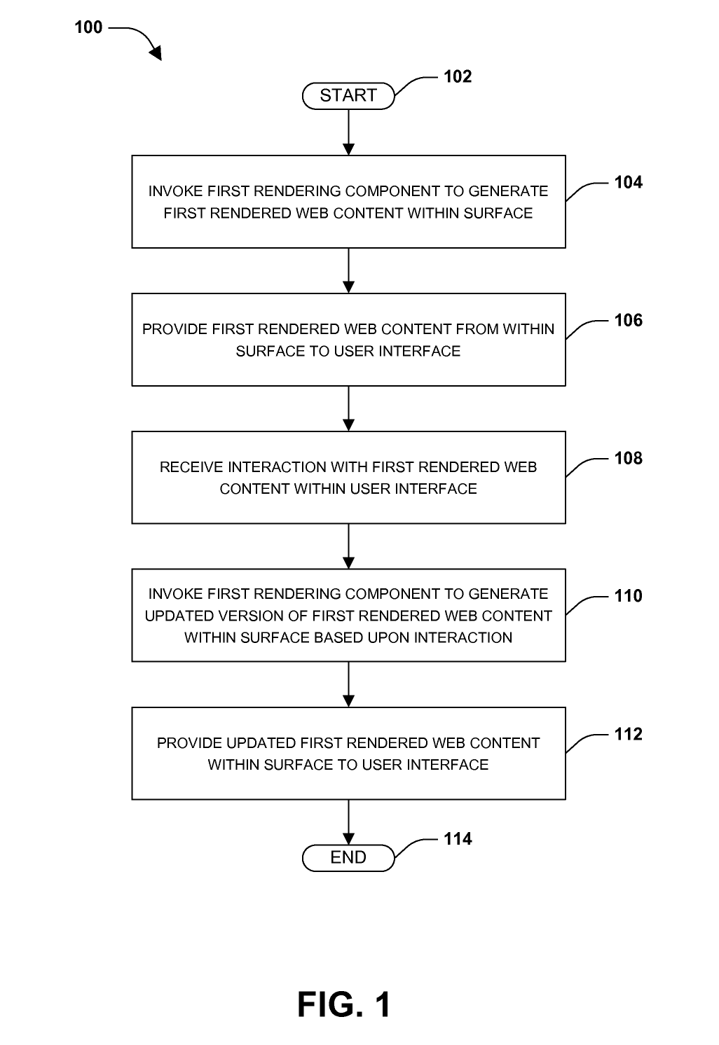

One embodiment of rendering web content within a user interface is illustrated by an exemplary method 100 in FIG. 1. At 102, the method starts. At 104, a first rendering component may be invoked to generate a first rendered web content within a surface. For example, an HTML renderer, such as a hidden instance of a web page, may render imagery of a hyperlink in a common format at a location within the surface. At 106, the first rendered web content from within the surface may be provided to a user interface (e.g., a non-web-based application). For example, rendered imagery of the hyperlink in a blue color may be provided to a multimedia desktop application, which may display the rendered imagery of the hyperlink in blue (e.g., within a cube object). The multimedia desktop application may display the hyperlink within a cube object in a lower right corner of the multimedia desktop application.

At 108, interaction with the first rendered web content within the user interface may be received. For example, a user may use a cursor to click (invoke) the hyperlink within the cube object. In this example, the interaction may comprise the click event, a position of the hyperlink within the multimedia desktop application, a position of the mouse, and/or other information. At 110, the first rendering component may be invoked to generate an updated version of the first rendered web content within the surface based upon the interaction and/or some other type of notification. For example, the interaction data (e.g., the click event, the position of the hyperlink, etc.) may be provided to the HTML renderer. The HTML renderer may generate an updated version of the hyperlink imagery (e.g., the updated imagery may comprise the hyperlink displayed in a different color, such as purple, to indicate that the hyperlink was invoked by the user). It may be appreciated that the first rendering component may make a determination not to generate an updated version of the first rendered web content, e.g., based upon some predetermined criteria, user settings, etc.

At 112, the updated first rendered web content within the surface may be provided to the user interface. For example, rendered imagery of the updated purple colored hyperlink may be provided to the multimedia desktop application, which may display the updated rendered imagery of the updated purple hyperlink. The multimedia desktop application may display the updated purple hyperlink, instead of the imagery of the blue hyperlink, within the cube object to indicate the hyperlink was invoked by the user.

It may be appreciated that more than one rendering component may be used to generate rendered web content in a common format within surfaces. In one example, a second rendering component (e.g., a DirectX® rendering component), may be invoked to generate a second rendered web content within the surface. For example, the second rendering component may generate a web-based textbox within the surface comprising the hyperlink. In one example, either the hyperlink or the textbox may be provided to the user interface. In another example, the hyperlink and the textbox may be combined into a combined rendered web content, which may be provided to the user interface. In this way, interactive web content rendered by one or more rendering technologies may be provided to a user interface in a compatible format. At 114, the method ends.

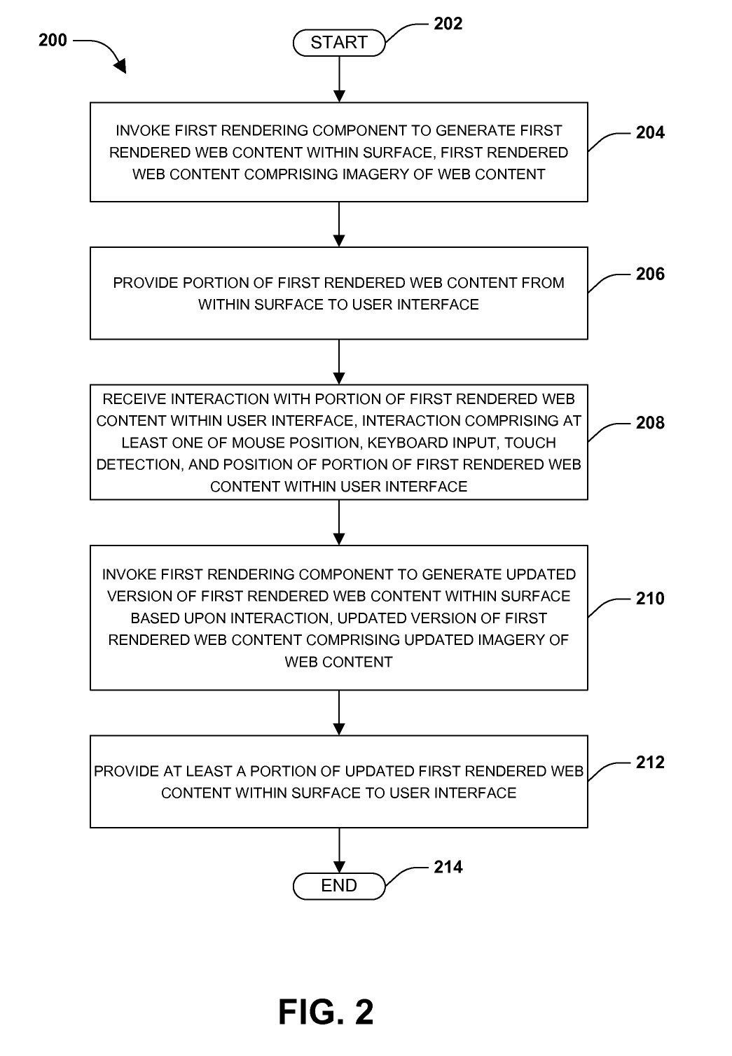

One embodiment of rendering web content within a user interface is illustrated by an exemplary method 200 in FIG. 2. At 202, the method starts. At 204, a first rendering component may be invoked to generate a first rendered web content within a surface. The first rendered web content may comprise imagery of web content. For example, an HTML renderer may generate imagery of a web-based table within a surface at a particular location. At 206, a portion of the first rendered web content from within the surface may be provided to a user interface. For example, imagery of the web-based table may comprise 15 rows. However, a portion of the imagery, for example the first ten rows of the web-based table, may be provided to the user interface.

At 208, interaction with the portion of the first rendered web content within the user interface may be received. The interaction may comprise a mouse position, a keyboard input, a touch detection, etc. and/or a position of the portion of the first rendered web content within the user interface. For example, a user may click within a cell of the web-based table displayed within the use interface (e.g., cell 2,3). The mouse click event, a mouse position (e.g., xy coordinate of the mouse indicative of the clicked cell) and/or a position of the portion of imagery (e.g., the first ten rows of the web-based table) as displayed within the user interface may be received.

At 210, the first rendering component may be invoked to generate an updated version of the first rendered web content within the surface based upon the interaction. The updated version of the first rendered web content may comprise update imagery of web content. For example, the HTML renderer may generate an updated version of the web-based table, such that a cursor is depicted within the clicked cell. At 212, at least a portion of the updated first rendered web content within the surface may be provided to the user interface. In one example, a portion of the updated imagery may comprise the first ten rows of the updated web-based table, which may include the updated cell. In another example, imagery of just the updated cell may be provided to the user interface. In this way, the user interface may present the first ten rows of the updated web-based table, such that a cursor is depicted in the clicked cell. At 214, the method ends.

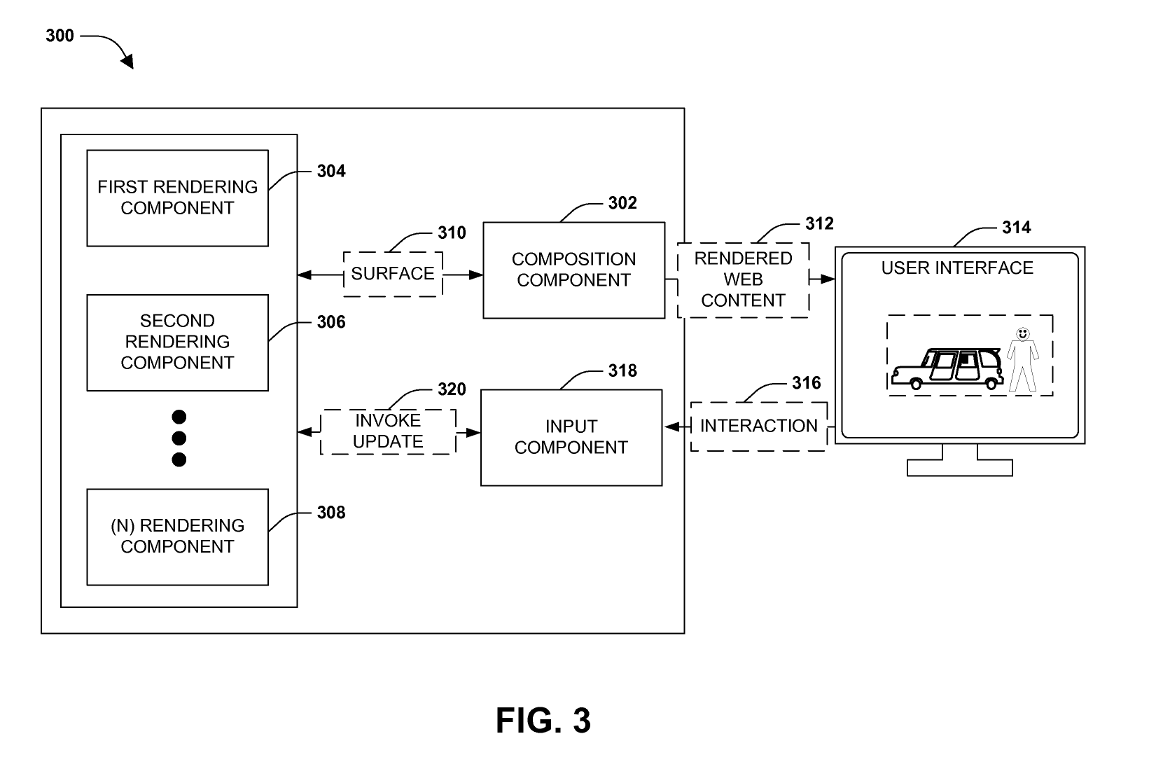

FIG. 3 illustrates an example of a system 300 configured to render web content within a user interface 314. The system 300 may comprise a first rendering component 304, a second rendering component 306, and/or other rendering components (e.g., Nth rendering component 308). It may be appreciated that the system 300 may comprise a single rendering component, such as the first rendering component 304. The system 300 may comprise a composition component 302 and/or an input component 318. The user interface 314 may be a non-web-based application, such as a desktop car research application.

The composition component 302 may be configured to send a surface 310 to a rendering component, such as the first rendering component 304 (e.g., an HTML renderer comprising a hidden instance of a web page). The first rendering component 304 may be configured to receive the surface 310 from the composition component 302. The first rendering component 304 may be configured to generate a first rendered web content within the surface 310. For example, the first rendering component 302 may render imagery of a car and a person in a common format. The first rendering component 302 may send the surface 310 to the composition component 302, which may be configured to receive the surface 310 comprising the first rendered web content (e.g., the rendered imagery of the car and the person) from the first rendering component 304. The composition component 302 may be configured to provide the rendered web content 312, such as the first rendered web content to the user interface 314.

It may be appreciated that composition component 302 may be configured to invoke multiple rendering components to generate rendered web content within the surface 310. It may be appreciated that one or more surfaces may be utilized in managing rendered web content generated by rendering components. In one example, the second rendering component 306 (e.g., a DirectX® renderer) may be configured to render a second rendered web content within the surface 310. For example, the second rendering component 306 may generate rendered imagery of a dashed box within the surface 310. In this way, the composition component 302 may provided the rendered web content 312 from various rendering components to the user interface 314 using one or more surfaces. For example, the composition component 302 may selectively provide either the first or the second rendered web content to the user interface 314. In another example, the composition component 302 may combine the first and second rendered web content into combined rendered web content, and provide the combined rendered web content to the user interface 314. It may be appreciated that the user interface 314, the input component 318, and/or the composition component 302 may be configured to request a rendering component to generate rendered web content on the surface 310.

The input component 318 may be configured to invoke 320 a rendering component, such as the first rendering component 304, to generate an updated version of rendered web content within the surface 310 based upon interaction 316 with the rendered web content within the user interface. For example, the user interface 314 may display the first rendered web content comprising imagery of a car and person. A user may mouseover the imagery of the car and person, which may be detected by the input component 318 as the interaction 316. The input component 318 may provide the mouseover event, a mouse position, and/or a position of the first rendered web content within the user interface 314 to the first rendering component 304. The first rendering component may generate an updated version of the first rendered web content (e.g., imagery depicting the car and person highlighted yellow) within the surface 310, which may be provided to the user interface 314 by the composition component 302. In this way, rendered web content may be updated and provided to the user interface 314 based upon user interactions, and thus allowing to interactive web content within the user interface 314.

It may be appreciated that the composition component 302 may be configured to “break-up” rendered web content within a surface into portions. For example, a first rendering component may render web content comprising a car and a person within a surface. The composition component 302 may be configured to split the car and the person into separate portions. In this way, the car may be provided to a user interface, such that the user interface may display the car at a first location. The person may be provided to the user interface, such that the user interface may display the person at a second location, where the first and second locations are different from the respective locations of these elements before being split up.

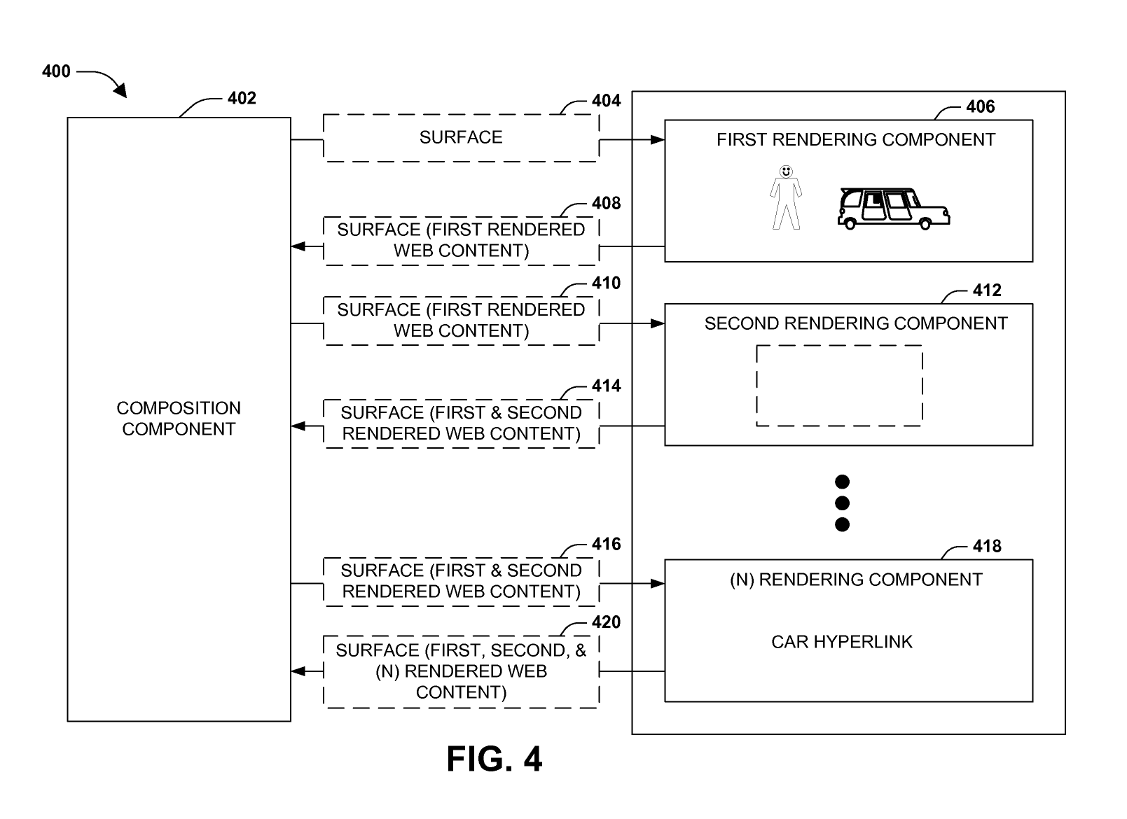

FIG. 4 is an illustration of an example 400 of a composition component 402 invoking multiple rendering components to generate rendered web content within a surface 404. The composition component 402 may send the surface 404 to a first rendering component 406. The first rendering component may generate a first rendered web content of a car and person within a surface 408. The composition component 402 may receive the surface 408 with the first rendered web content.

The composition component 402 may send a surface 410 comprising the first rendered web content to the second rendering component 412. The second rendering component 412 may generate a second rendered web content of a dashed box within a surface 414. The composition component 402 may receive the surface 414 with the first rendered web content and the second rendered web content.

The composition component 402 may send a surface 416 with the first rendered web content and the second rendered web content to an Nth rendering component 418. The Nth rendering component 418 may generate an Nth rendered web content of a car hyperlink within a surface 420. The composition component 402 may receive the surface 420 with the first rendered web content, the second rendered web content, and the Nth rendered web content. It may be appreciated that the various surfaces (404, 408, 410, 414, 416, and/or 420) referred to in example 400 may be the same or different surfaces. In this way, the composition component 402 may collect rendered web content on one or more surfaces from various rendering components.

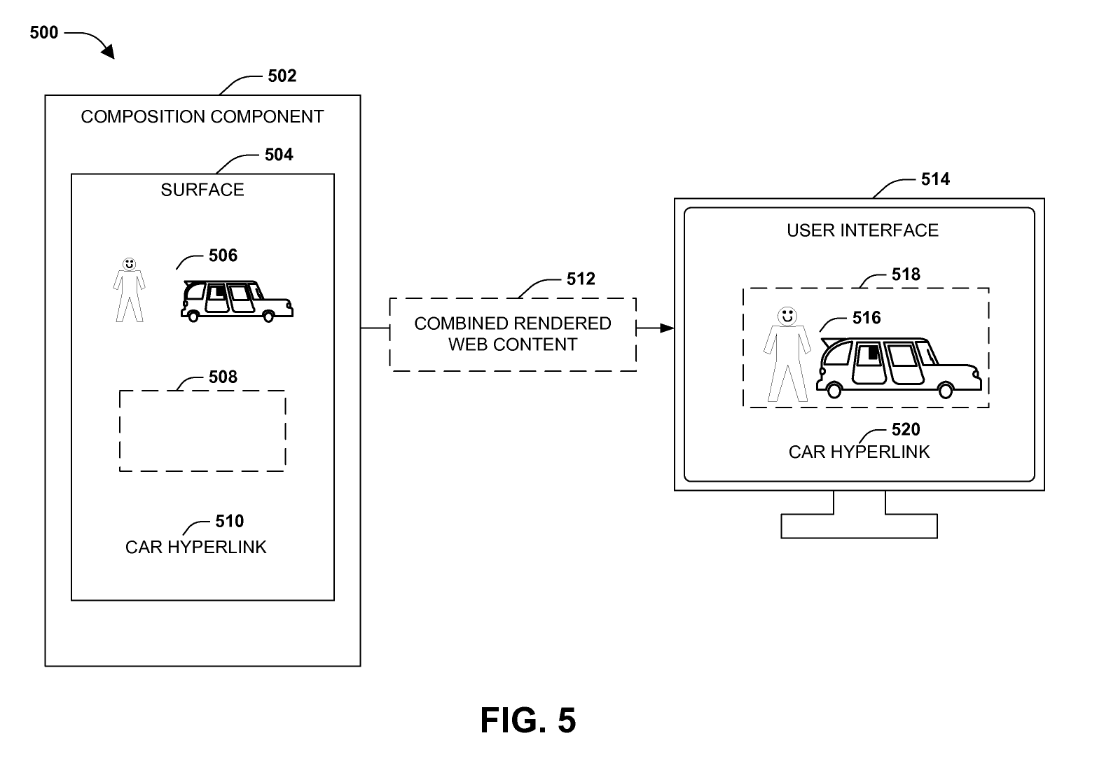

FIG. 5 is an illustration of an example 500 of providing combined rendered web content 512 to a user interface 514. A composition component 502 may have collected web content (e.g., imagery) within a surface 504. For example, the surface 504 may comprise a first rendered web content 506 of a car and person, a second rendered web content 508 of a dashed box, and/or a third rendered web content 510 of a car hyperlink. The composition component 502 may combine the first, second, and third web content into the combined rendered web content 512 comprising imagery of a car, a person, a dashed box, and a car hyperlink. The composition component 502 may provide the combined rendered web content 512 to the user interface 514. The user interface 514 may display the imagery within the combined rendered web content 512 within the displayed user interface 514. For example, a car and person imagery 516 may be displayed within a dashed box imagery 518, while a car hyperlink imagery 520 may be displayed below within the user interface 514.

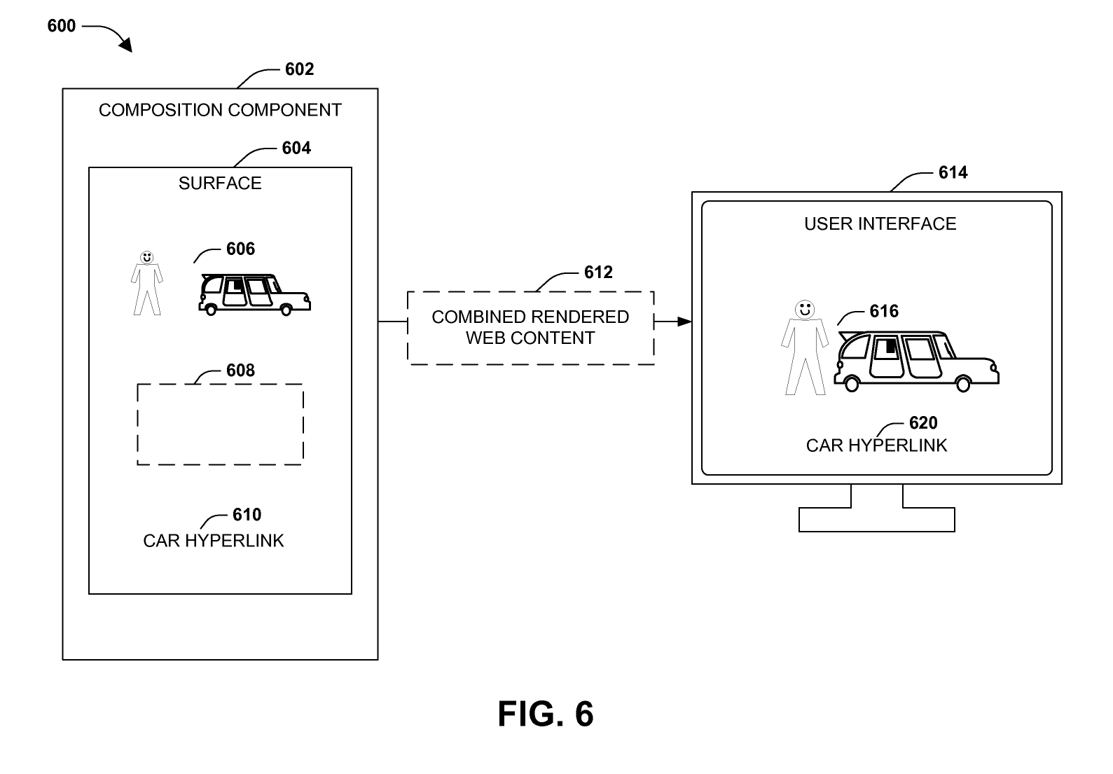

FIG. 6 is an illustration of an example 600 of providing combined rendered web content 612 to a user interface 614. A composition component 602 may have collected web content (e.g., imagery) within a surface 604. For example, the surface 604 may comprise a first rendered web content 606 of a car and person, a second rendered web content 608 of a dashed box, and/or a third rendered web content 610 of a car hyperlink. The composition component 602 may combine the first and third web content (but not the second web content) into the combined rendered web content 612 comprising imagery of a car, a person, and a dashed box. The composition component 602 may provide the combined rendered web content 612 to the user interface 614. The user interface 614 may display the imagery within the combined rendered web content 612 within the displayed user interface 614. For example, a car and person imagery 616 may be displayed above a car hyperlink imagery 620 within the user interface 614.

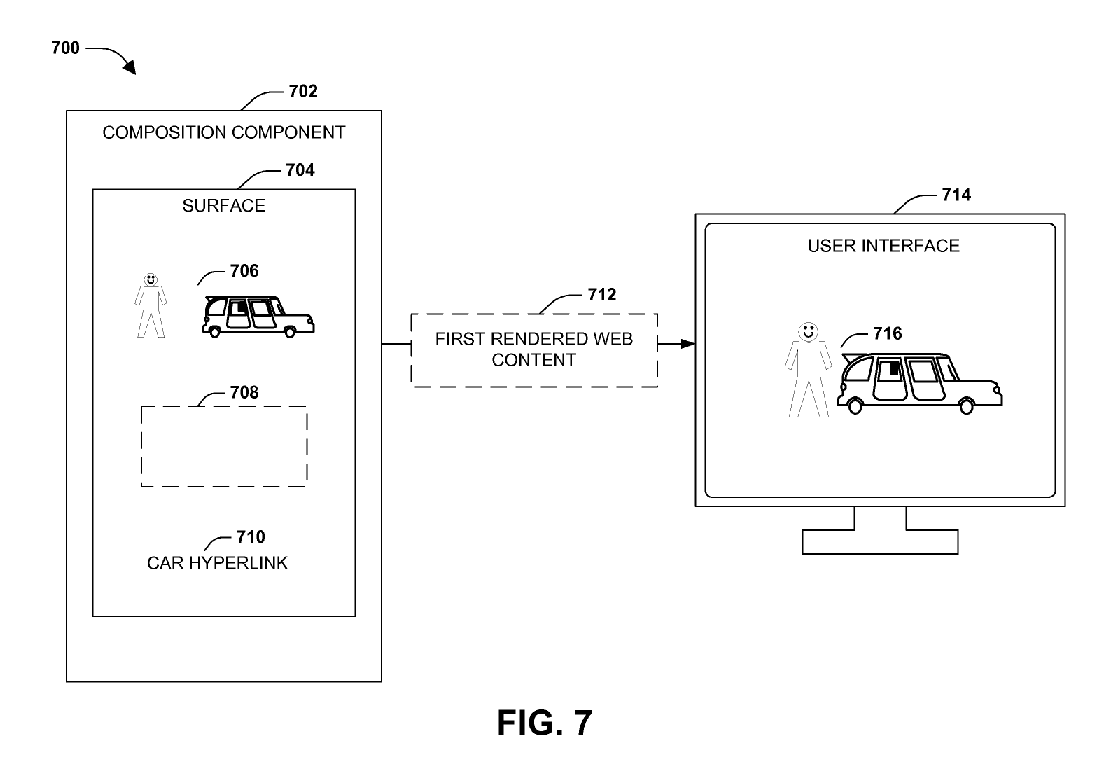

FIG. 7 is an illustration of an example 700 of providing a first rendered web content 712 to a user interface 714. A composition component 702 may have collected web content (e.g., imagery) within a surface 704. For example, the surface 704 may comprise a first rendered web content 706 of a car and person, a second rendered web content 708 of a dashed box, and/or a third rendered web content 710 of a car hyperlink. The composition component 702 may provide the first rendered web content 712 comprising imagery of the car and person to the user interface 714. The user interface 714 may display the car and person imagery 716 within the first rendered web content 712 within the displayed user interface 714.

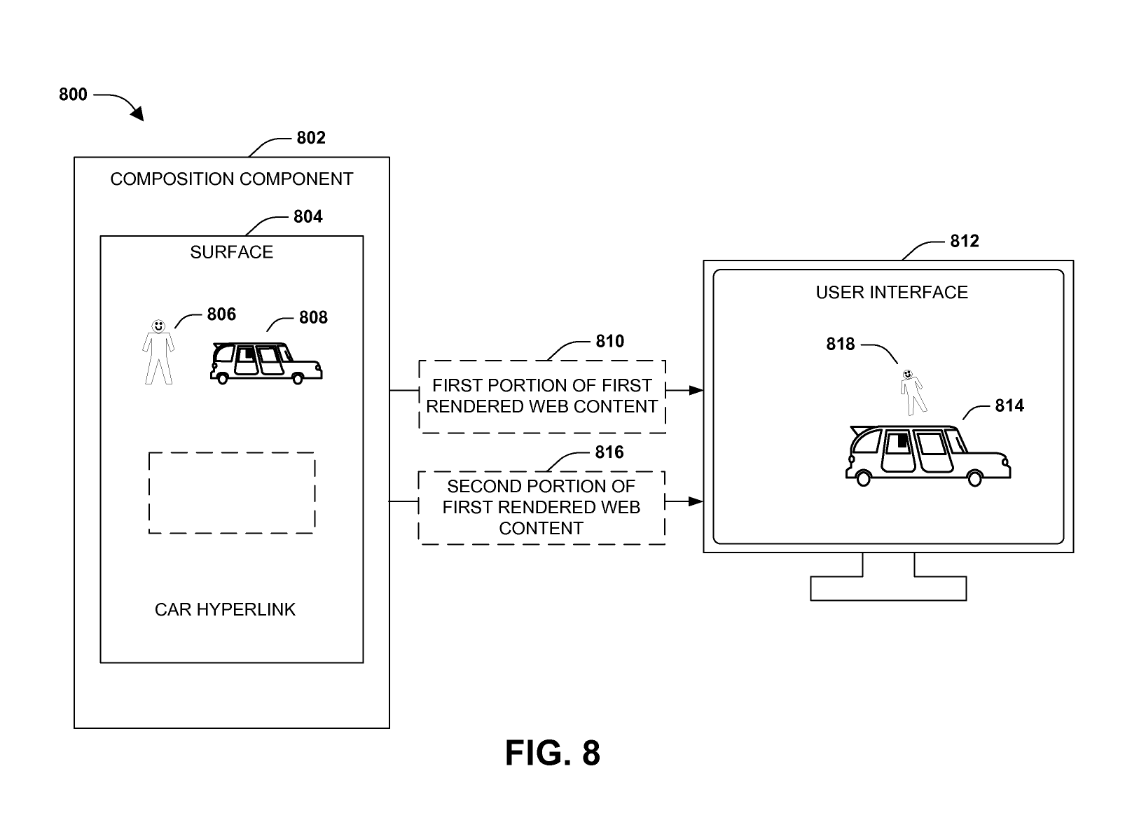

FIG. 8 is an illustration of an example 800 of providing a first and second portion of a first rendered web content to a user interface 812. A composition component 802 may have collected web content (e.g., imagery) within a surface 804. For example, the surface 804 may comprise a first rendered web content of a car 808 and a person 806, along with other rendered web content. The composition component 802 may provide the first portion of the first rendered web content 810 comprising imagery of the car 808 portion, but not the person 806 portion of the first rendered web content to the user interface 812. The user interface 812 may display the car imagery 814 within the first portion of the first rendered web content 810 within the displayed user interface 812 at a first location. Additionally, the composition component 802 may provide the second portion of the first rendered web content 816 comprising imagery of the person 806 portion, but not the car 808 portion of the first rendered web content to the user interface 812. The user interface may display the person imagery 818 within the second portion of the first rendered web content 810 at a second location (e.g., above the car instead of beside/behind the car, as initially depicted).

It will be appreciated that other imagery such as a hyperlink, for example, could also be displayed in the user interface 812 where merely a portion of other content is displayed in the user interface. For example, hyperlink imagery could be displayed along with car 808 portion where person 806 portion is not displayed.

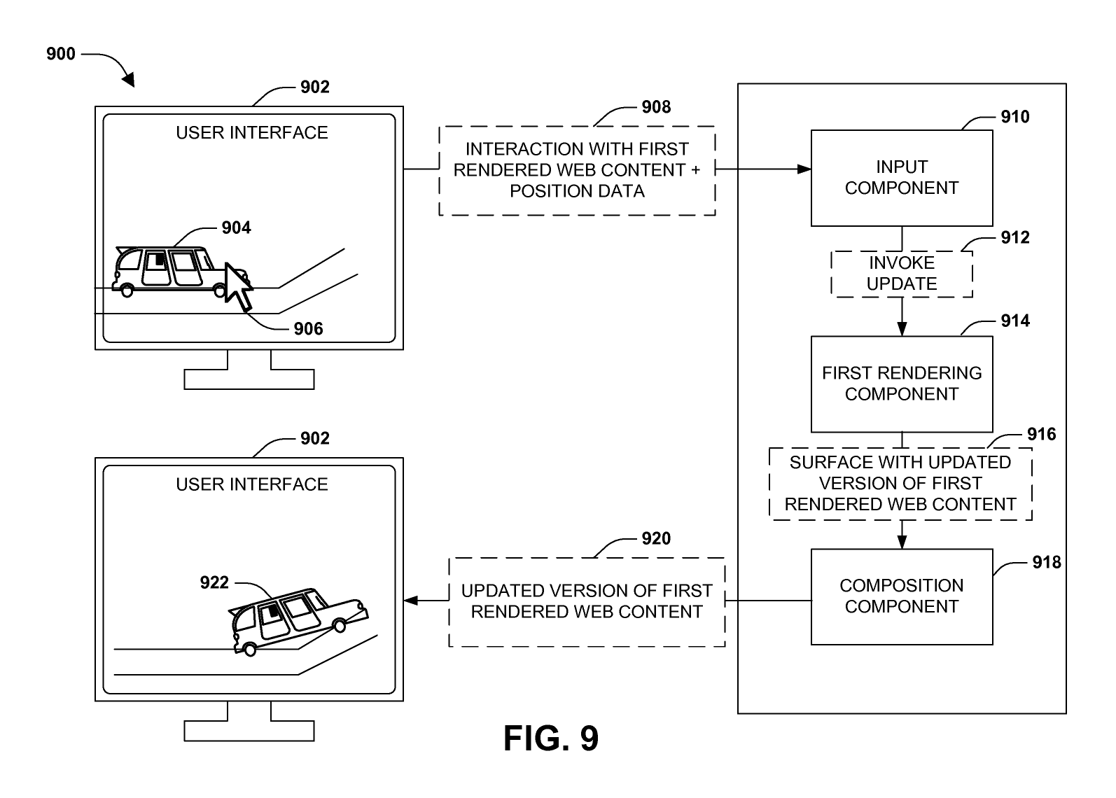

FIG. 9 is an illustration of an example 900 of an input component 910 invoking a first rendering component 914 to generate an updated version 916 of a first rendered web content within a surface. A user interface 902 may display a first rendered web content 904 comprising imagery of a car. A mouseclick on the first rendered web content 904 may be invoked by a cursor 906 selecting the car. The input component 910 may detected an interaction 908 with the first rendered web content 904, along with position data (e.g., mouse position, a keyboard input, a tactile detection, and/or a position of the first rendered web content 904 within the user interface 902). The input component 910 may invoke 912 the first rendering component 914 to generate the updated version 916 of the first rendered web content within a surface. For example, the first rendering component 914 may generate the updated version 916 comprising imagery of the car in a different orientation (e.g., the car may be depicted in a tilted upward position as if the car is driving up a hill) and/or location within the surface (e.g., the updated imagery of the car may be rendered at a location further to the right as if the car has driven to the right up a hill).

A composition component 918 may be configured to provide the updated version 920 of the first rendered web content to the user interface 902. The user interface 902 may display the updated car imagery 922. In this way, interaction (e.g., user interaction, a timer expiration, and/or other events) may be used to update rendered web content. For example, the car imagery 922 may be subsequently updated one or more times to depict motion of the car within the user interface 902.

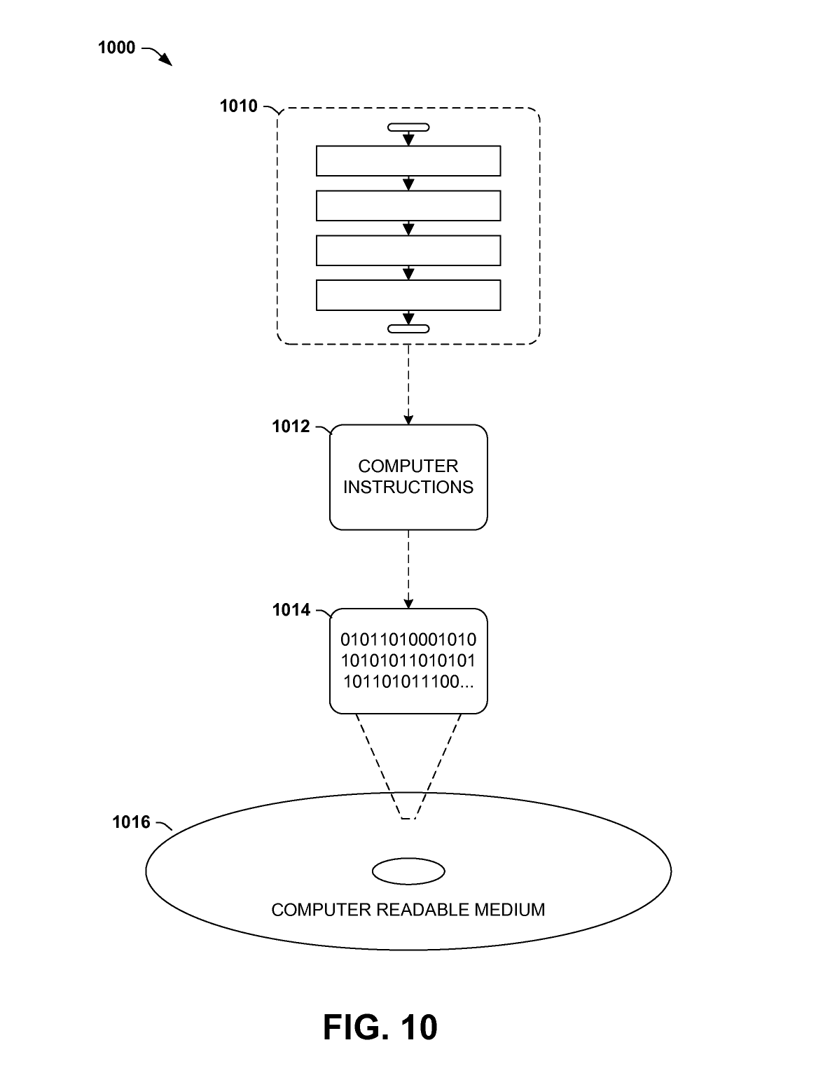

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1016 (e.g., a CD-R, DVD-R, or a platter of a hard disk drive), on which is encoded computer-readable data 1014. This computer-readable data 1014 in turn comprises a set of computer instructions 1012 configured to operate according to one or more of the principles set forth herein. In one such embodiment 1000, the processor-executable computer instructions 1012 may be configured to perform a method 1010, such as the exemplary method 100 of FIG. 1 and/or exemplary method 200 of FIG. 2, for example. In another such embodiment, the processor-executable instructions 1012 may be configured to implement a system, such as the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

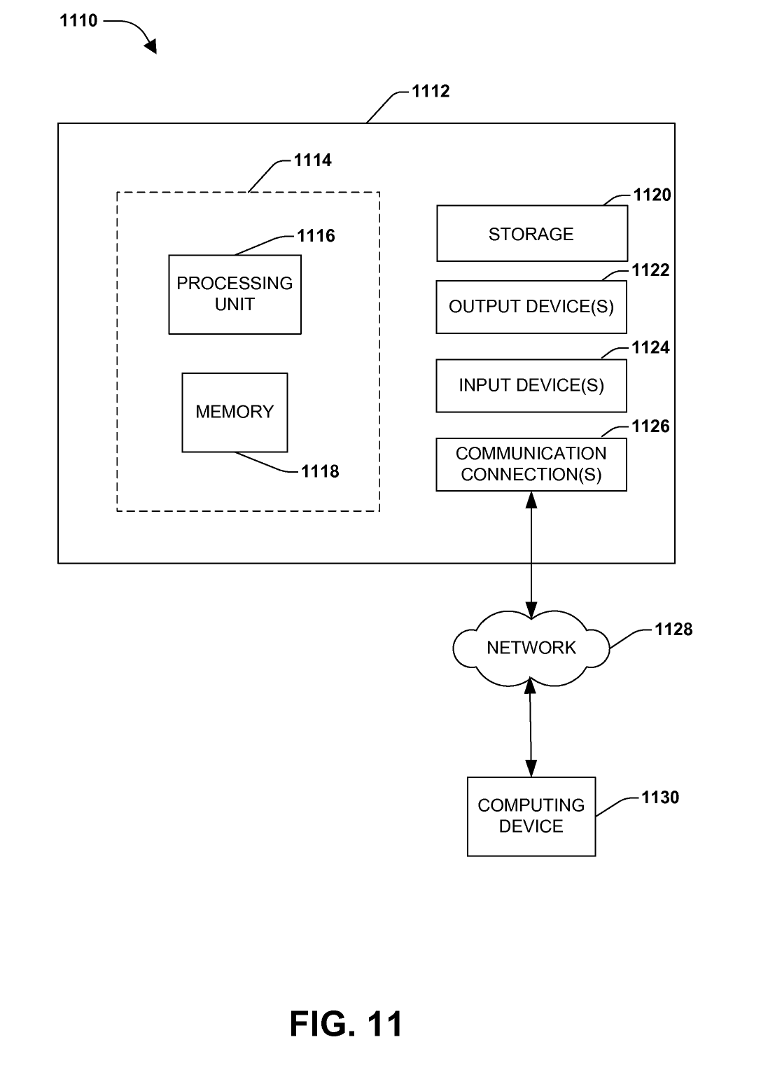

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 13114), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system for rendering web content within a user interface, comprising:
a composition component configured to:
send a surface to a first rendering component;
receive the surface comprising a first rendered web content from the first rendering component; and
provide the first rendered web content to a user interface;
the first rendering component configured to:
receive the surface from the composition component;
generate the first rendered web content within the surface; and
send the surface comprising the first rendered web content to the composition component; and
an input component configured to:
invoke the first rendering component to generate an updated version of the first rendered web content based upon interaction with the first rendered web content within the user interface.

2. The system of claim 1, the first rendering component comprising an HTML renderer.

3. The system of claim 2, the HTML renderer comprising a hidden instance of a web page.

4. The system of claim 1, comprising:
a second rendering component configured to:
receive the surface from the composition component;
generate a second rendered web content within the surface; and
send the surface comprising the first rendered web content and the second rendered web content to the composition component.

5. The system of claim 4, the second rendering component comprising a DirectX® renderer.

6. The system of claim 4, the composition component configured to:
send the surface comprising the first rendered web content to the second rendering component; and
receive the surface comprising the first rendered web content and the second rendered web content from the second rendering component.

7. The system of claim 6, the composition component configured to:
combine the first rendered web content and the second rendered web content into a combined rendered web content; and
provide the combined rendered web content to the user interface.

8. The system of claim 6, the composition component configured to:
selectively provide either the first or the second rendered web content to the user interface.

9. The system of claim 1, the user interface comprising a non-web-based application.

10. The system of claim 1, the first rendered web content relating to at least one of an interactive user interface and a video.

11. The system of claim 1, the input component configured to send at least one of a mouse position, a keyboard input, a touch detection, and a position of the first rendered web content within the user interface to the first rendering component.

12. The system of claim 1, the composition component configured to:
provide a first portion of the first rendered web content to the user interface for display at a first position within the user interface; and
provide a second portion of the first rendered web content to the user interface for display at a second position within the user interface.

13. The system of claim 1, the first rendering component configured to render the first rendered web content at a location within the surface.

14. A method for rendering web content within a user interface, comprising:
invoking a first rendering component to generate a first rendered web content within a surface;
providing the first rendered web content from within the surface to a user interface;
receiving interaction with the first rendered web content within the user interface;
invoking the first rendering component to generate an updated version of the first rendered web content within the surface based upon the interaction; and
providing the updated first rendered web content within the surface to the user interface.

15. The method of claim 14, comprising:
invoking a second rendering component to generate a second rendered web content within the surface.

16. The method of claim 15, comprising:
selectively providing either the first or the second rendered web content to the user interface.

17. The method of claim 15, comprising:
combining the first rendered web content and the second rendered web content into a combined rendered web content; and
providing the combined rendered web content to the user interface.

18. The method of claim 14, the invoking the first rendering component to generate an updated version of the first rendered web content comprising:
providing at least one of a mouse position, a keyboard input, a touch detection, and a position of the first rendered web content within the user interface to the first rendering component.

19. The method of claim 14, the providing the first rendered web content from within the surface to a user interface comprising:
providing a first portion of the first rendered web content to the user interface for display; and
providing a second portion of the first rendered web content to the user interface for display.

20. A method for rendering web content within a user interface, comprising:
invoking a first rendering component to generate a first rendered web content within a surface, the first rendered web content comprising imagery of web content;
providing a portion of the first rendered web content from within the surface to a user interface;
receiving interaction with the portion of the first rendered web content within the user interface, the interaction comprising at least one of a mouse position, a keyboard input, a touch detection, and a position of the portion of the first rendered web content within the user interface;
invoking the first rendering component to generate an updated version of the first rendered web content within the surface based upon the interaction, the updated version of the first rendered web content comprising updated imagery of web content; and
providing at least a portion of the updated first rendered web content within the surface to the user interface.
